(19) United States
(12) Patent Application Publication
(10) Pub. No.: US 2007/0277154 A1
(43) Pub. Date: Nov. 29, 2007

(54) TESTING DISTRIBUTED COMPONENTS

(75) Inventor: Ashutosh M. Badwe, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/419,901

(22) Filed: May 23, 2006

(51) Int. Cl. G06F 9/44

(52) U.S. Cl. 717/124

(57) ABSTRACT

The present invention extends to methods, systems, and computer program products for testing distributed components. A test case definition indicates how APIs are to be called to test components of a distributed system. A test driver can execute the test case definition to invoke the APIs. Results of the APIs can be stored. A test case definition can use output from an API testing one distributed component as input to another API for testing a different distributed component. Accordingly, end to end integration testing is possible for computing functionality that spans multiple components of a distributed system

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, and database management) that prior to the advent of the computer system were performed manually. More recently, computer systems have been coupled to one another and to other electronic devices to form both wired and wireless computer networks over which the computer systems and other electronic devices can transfer electronic data. As a result, the performance of many computing tasks are distributed across a number of different computer systems and/or a number of different computing components.

For example, a Web server component can perform operations on data and then pass the data to a database component. The database component can perform further operations on the data and pass the data to a Component Object Model (“COM”) component. The COM component can perform still further operations on the data and pass the data to a further different component, etc.

Generally, to insure proper operation of software components, software components are tested before being included in production releases. Testing tools, designed for use with a specified component, can be used to simulate operating conditions the specified component may encounter in commercial use. A tester can use a testing tool to input (or write) tests against the specified component. The test tool can then execute the test, for example, providing input to and recording output from the specified component, to determine how the specified component responds.

Thus, a corporation that develops databases may use a testing tool designed for use with a database component to test the database component before it is included in a commercial product. Similarly, a different corporation that develops Web servers may use a different testing tool designed for use with a Web server component before it is included in a commercial product. Other corporations can use other testing tools to perform similar tests on components they develop.

However, testing a plurality of different (and potentially separately developed) software components individually provides no guarantee that the different components will appropriately interoperate when used together in a distributed system. For example, there is no guarantee that a Web server component and a Database component can interoperate in a desired manner when used in a distributed system, even if the Web server component and the Database component appear to function properly when individually tested. Further, when errors do occur in a distributed system there is typically no mechanism to test the distributed system to identify the cause of the error.

Difficulties in identifying the cause of errors can increase, potentially significantly, as the number of software components included in a distributed system also increases. For example, a distributed system may include first, second, third and fourth software components. Due interoperation and interdependency between software components in a distributed system, an error in the distributed system may not be revealed at the component the actually caused the error. For example, the first software component may function in a way (e.g., data formatting, messaging techniques, etc.) that causes an error to occur at the third software component.

Unfortunately, testing tools are typically software component specific and self-contained. Thus, there is no efficient way to design a single test that can test an entire distributed system. One particular deficiency results from an inability of most, if not all, testing tools to model a connection between different software components in a distributed system. That is, a Web server test tool can test a Web server component and a Database test tool can test a Database component, but neither the Web server test tool nor the Database test tool can test an interconnection between the Web server component and the Database component. As a result, it may be difficult, if not impossible, to identify a connection between software components as the cause of an error in a distributed system.

Further, test tools for different software components are typically not compatible with one another. Thus, there is no efficient way to transfer data between test tools for different software components. For example, there may be no way to transfer data from a Database component test tool to a COM component test tool and vice versa. Accordingly, there is typically no efficient way to leverage tests results from testing one software component in a distributed system to assist in testing another software component in the distributed system.

### BRIEF SUMMARY

The present invention extends to methods, systems, and computer program products for testing distributed components. In some embodiments, components of a distributed system are tested. A test case definition that defines test directives for testing a plurality of different components in the distributed system is received. The test case definition defines test directives for testing at least first and second interconnected components.

A first test directive is accessed from the test case definition file. It is identified that the first test directive is directed to an API included in a first test library, wherein APIs included in the first test library are configured to test the functionality of the first component. The first API is dynamically invoked with parameters included in the first test directive to test the functionality of the first component. Results from the first API testing the first component are received.

A second test directive is accessed from the test case definition file. It is identified that the second test directive is directed to an API included in a second different test library, wherein APIs included in the second different test library are configured to test the functionality of the second component. The second API is dynamically invoked parameters included in the second test directive to test the functionality of the second component. Results from the second API testing the second component are received.

In other embodiments, a test case definition for testing a distributed system is created. One or more test libraries including exposed APIs for testing components of the distributed system are accessed. The exposed APIs are discovered. Information indicating how the exposed APIs are to be invoked is stored. A map of the distributed system along with a list of available APIs per distributed component is presented at a user-interface. A user selection indicating that a specified API is to be called to test a component of the distributed system is received. The stored information is automatically utilized to create a test directive appropriately calling the API such that the user is relieved from having to know how to create the test directive.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates testing distributed components.

FIG. 2 illustrates a flow chart of an example method for testing distributed components.

FIG. 3 illustrates an example computer architecture that facilitates automated generation and execution of distributed component tests.

### DETAILED DESCRIPTION

The present invention extends to methods, systems, and computer program products for testing distributed components. In some embodiments, components of a distributed system are tested. A test case definition that defines test directives for testing a plurality of different components in the distributed system is received. The test case definition defines test directives for testing at least first and second interconnected components.

A first test directive is accessed from the test case definition file. It is identified that the first test directive is directed to an API included in a first test library, wherein APIs included in the first test library are configured to test the functionality of the first component. The first API is dynamically invoked with parameters included in the first test directive to test the functionality of the first component. Results from the first API testing the first component are received.

A second test directive is accessed from the test case definition file. It is identified that the second test directive is directed to an API included in a second different test library, wherein APIs included in the second different test library are configured to test the functionality of the second component. The second API is dynamically invoked parameters included in the second test directive to test the functionality of the second component. Results from the second API testing the second component are received.

In other embodiments, a test case definition for testing a distributed system is created. One or more test libraries including exposed APIs for testing components of the distributed system are accessed. The exposed APIs are discovered. Information indicating how the exposed APIs are to be invoked is stored. A map of the distributed system along with a list of available APIs per distributed component is presented at a user-interface. A user selection indicating that a specified API is to be called to test a component of the distributed system is received. The stored information is automatically utilized to create a test directive appropriately calling the API such that the user is relieved from having to know how to create the test directive.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise computer-readable storage media, such as, RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer, the computer properly views the connection as a computer-readable medium. Thus, by way of example, and not limitation, computer-readable media can comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

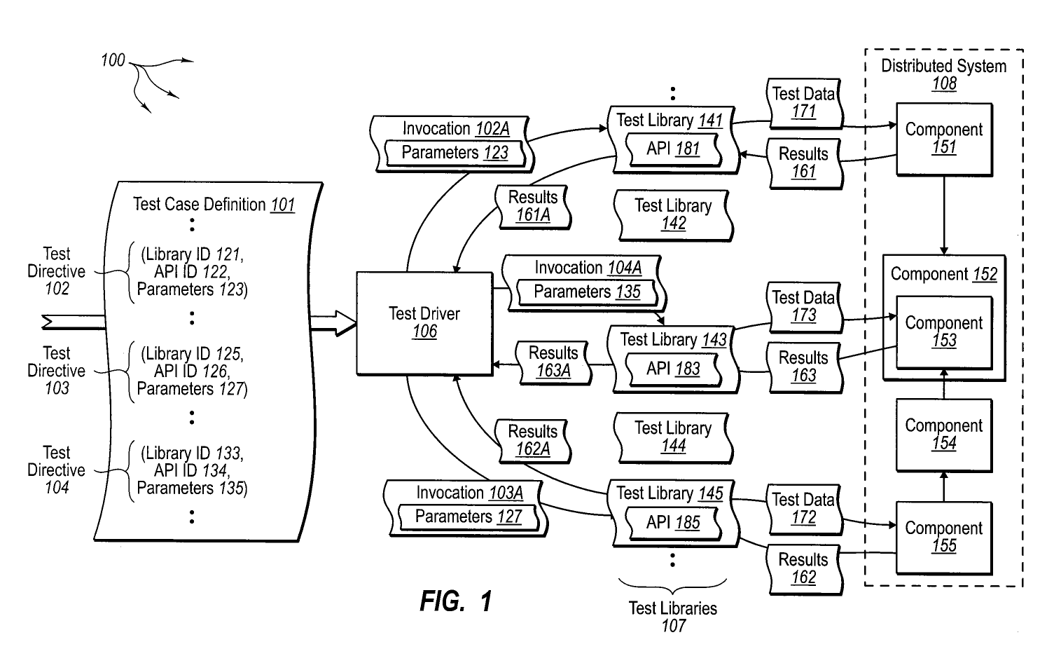

FIG. 1 illustrates example computer architecture 100 that facilitate testing distributed components. Computer architecture 100 includes test driver 106, test libraries 107, and distributed system 108. Each of the components computer be connected to a network, such as, for example, a Local Area Network (“LAN”), a Wide Area Network (“WAN”), or even the Internet. Thus, the various components can receive data from and send data to each other, as well as other components connected to the network. Accordingly, the components can create message related data and exchange message related data (e.g., Internet Protocol (“IP”) datagrams and other higher layer protocols that utilize IP datagrams, such as, Transmission Control Protocol (“TCP”), Remote Desktop Protocol (“RDP”), Hypertext Transfer Protocol (“HTTP”), Simple Mail Transfer Protocol (“SMTP”), etc.) over the network.

Distributed system 108 includes integrated components, 151, 152, 153, 154, and 155. The components 151, 152, 153, 154, and 155 can be integrated to perform various distributed computing tasks as desired by an administrator or user of distributed system 108. Arrows between the various components 151, 152, 153, 154, and 155 indicate direction of data flow. For example, component 152 can be an Internet Information Service component that includes component 153, a SQL database component. As depicted by the dataflows, component 152 and/or component 153 can exchange data with component 151 or with a data path including component 155 to component 154.

Component 151 can be an Internet Information Service server component configured to send data to and access data from the Internet Information Server and/or the SQL database. Component 155 can be a personal computer application component (e.g., an operating system component, Win32 component, Common Object Model (“COM”) component, etc.) running on a personal computer system. Component 154 can be an Internet Information Service Web server component. Thus, a user of component 155 can use a Web based interface of component 154 to send data to and received data from the SQL database.

Generally, test driver 106 is configured to receive test case definitions and cause test to be executed against components of distributed system 108 in accordance with tests defined in the test case definitions. Test driver 106 can dynamically invoke Application Program Interfaces (“APIs”) included in test libraries to cause tests to occur. Test driver 106 can also receive test results and log the results in accordance with a specified logging format. Test driver 106 can maintain a table of test results, such as, for example, a hash table. Test directives included in test case definitions can reference the hash table to use the results (output) from previous test directives as input for further tests.

Test libraries of exposed APIs can be used to test components that do not include exposed APIs for testing. The exposed APIs provide an interface to test driver 106 and can be configured to appropriately call functionality of a tested component.

Test libraries 107 includes test library 141, 142, 143, 144, and 145. Each of test libraries 141, 142, 143, 144, and 145 can include APIs for testing one or more components of distributed system 108. In some embodiments, a test library includes a plurality of APIs for testing different portions of a single distributed component. For example, test library 141 can include a plurality of APIs each configured for testing component 151. However, in other embodiments a test library can include APIs directed at a plurality of different distributed components. For example, test library 142 can include a plurality of APIs some configured for testing component 151 and some configured for testing comment 152.

Test driver 106 can provide appropriate information (e.g., an API identifier and corresponding parameters) to a test library to cause an API form the test library to be dynamically invoked. For example, in response to receiving an API identifier and corresponding parameters from test driver 106, a test library can use reflection to query its own metadata. The test library can then use the queried metadata to invoke the identified API with the corresponding parameters. Invocation of the API can cause test data to be sent to a targeted component of distributed system 108. Results can subsequently be returned from the targeted component to the invoked API. The test library can in turn forward the (potentially reformatted) test results to test driver 106. Test driver 106 can log the results for later retrieval and/or viewing by a user.

Generally, a test case definition can include one or more test directives. Each test directive can provide information to test driver 106 for calling an API in a test library with corresponding parameters. A test case definition file can include test directives directed at plurality of different components of a distributed system. A test case definition can be generated manual or using automated mechanisms.

As depicted, test case definition 101 includes test directives 102, 103, and 104. Each of the test directives 102, 103 and 104 are directed to different components of component 108. For example, in test directive 101 Library ID 121 is an identifier for test library 141 used to test component 151. In test directive 102 Library ID 125 is an identifier for test library 145 used to test component 155. In test directive 103 Library ID 133 is an identifier for test library 143 used to test component 153.

The contents of a test case definition -file can be in any of variety of different formats, such as, for example, plain text, eXtensible Markup Language (“XML”) instructions, instructions of an interpretable programming language, etc. Thus, for example, test case definition 101 can include XML instructions.

Test case definitions can be configured in a variety of different ways. In some embodiments, test case definitions are configured for linear execution, for example, from top to bottom. For test case definition 101, test directive 102 can be executed first, then test directive 103, then test directive 104, etc. A test case definition can also include tests for a component in different locations with in the test case definition. For example, the follow pseudo-code example represents a plurality of tests for a plurality of different components in distributed system 108:

| | |
|---|---|
| <Test Case Definition> | |
| <Library ID 121> | // ID of test library 141 |
| <API ID 122, Parameters 123> | // Test directive 102 |
| <API ID 56, Parameters 57> | //Further test directive for |
| | component 151 |
| </Library ID 121> | |
| <Library ID 125> | // ID of test library 145 |
| <API ID 126, Parameters 127> | // Command 103 |
| </Library ID 125> | |
| <Library ID 133> | //ID of test library 143 |
| <API ID 134, Parameters 127> | // Command 104 |
| </Library ID 125> | |
| <Library ID 121> | //ID of test library 141 |
| <API ID 58, Parameters 59> | // Further test directive for |
| | component 151 |
| </Library ID 121> | |
| </Test Case Definition> | |

Test driver 106 can be corresponding configured to parse the contents of a test case definition file in any of a variety of different formats, such as, for example, plain text, XML instructions, instructions of an interpretable programming language, etc., to extract appropriate information for invoking an API. For example, test driver 106 can parse test case definition file 101 to extract Library ID 121, API ID, and Parameters 123 from test directive 102. Similarly, test driver 106 can parse the pseudo-code example and extract appropriate information for testing components 151, 153, and 155 as indicated in the pseudo-code example.

A test case definition can also include commands for providing the output of a prior test as input for a subsequent test. For example, test case definition file 101 can include further commands indicating that some of the values for parameters 127 are to be taken from results 161A (i.e., the results of invoking test directive 102). A test case definition can also include looping and conditional statements. Looping and conditional statements can be utilized to create for complex test directives. For example, test directives that loop through a series of tests a plurality of times or perform specified tests when the results of prior tests have particular values. Test driver 106 can be configured to appropriately parse commands that indicate returned results are to be used as parameters for a subsequent tests and looping and conditional statements.

A test case definition can also include variables that reference values stored in other locations external to the test case definition. For example, a test case definition can refer to values stored in a hash table (e.g., using the $HASHTABLE statement). A test case definition can also refer to global stored values, such as, for example, in system memory (e.g., using the $GLOBAL statement).

In some embodiments, exposed APIs are included in components of a distributed system. Thus, the functionality of test libraries as depicted in computer architecture 100 can be built into corresponding components of distributed system 108. For example, the APIs of test library 141 may be built into component 151. Thus, although FIG. 1 depicts test libraries as separate from corresponding components (and thus not included in distributed system 108), APIs included the depicted test libraries could instead be included in the components of distributed system 108.

In other embodiments, exposed APIs are included both in external libraries and in components. Thus, some components can be tested using exposed APIs from test libraries, other components can be tested using exposed APIs included in the components, and yet other components can be test using both exposed APIs from test libraries and exposed APIs included in the components. Thus, it may be that a separate test library for a component includes exposed APIs that supplement exposed APIs included in the component.

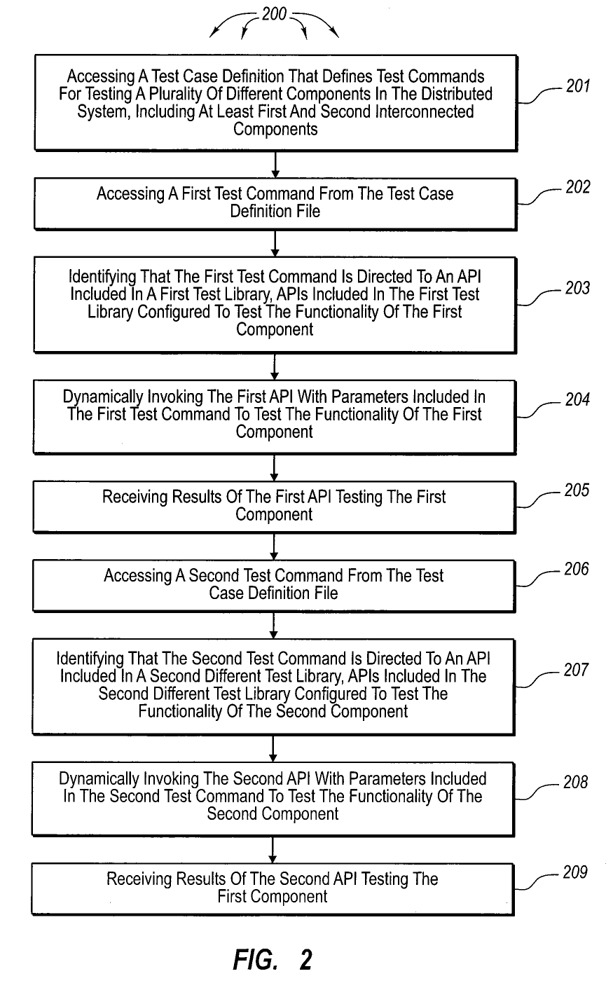

FIG. 2 illustrates a flow chart of an example method 200 for testing distributed components. The method 200 will be described with respect to the components and data in computer architecture 100.

Method 200 includes an act of accessing a test case definition that defines test directives for testing a plurality of different components in a distributed system, including at least first and second interconnected components (act 201). For example, test driver 106 can receive test case definition 101 that defines test directives for test components 151, 153, and 155.

Method 200 includes an act of accessing a first test directive from the test case definition file (act 202). For example, test driver 106 can access test directive 102. Method 200 includes an act of identifying that the first test directive is directed to an API included in a first test library, APIs included in the first test library configured to test the functionality of the first component (act 203). For example, test driver 106 can identify that test directive 102 is directed to API 181 in test library 141. Test driver 106 can used library ID 121 to identify test library 141 and API ID 122 to identify API 181.

Method 200 includes an act of dynamically invoking the first API with parameters included in the first test directive to test the functionality of the first component (act 204). For example, test driver 106 can issue invocation 102A to cause API 181 to be dynamically invoked with parameters 123 to test the functionality of component 151.

Invocation of API 181 can cause test data 171 to be sent to component 151. Component 151 can respond with results 161 indicating the component 151's response to test data 171. Test data 171 can include a call to a portion of the functionality of component 151 to simulate a condition component 151 can encounter during normal operation (e.g., an interaction with a series of other components in distributed system 108). Results 161 can indicate how component 151 responded to the simulated condition. For example, results 161 can indicate if component 151 responded as intended, if there was a performance deviation, if an error occurred, etc. Test library can appropriately format test data 161 into test data 161A and send test data 161A to test driver 106.

Method 200 includes an act of receiving results of the first API testing the first component (act 205). For example, test driver 106 can receive results 161A from test library 141. Test driver 106 can log results 161A and/or provide results 161A as input for a subsequent test. Test driver 106 can also store results 161A in a table, such as, for example, a hash table, such that other test directives can access results 161A and use results 161A as input for other tests.

Method 200 includes an act of accessing a second test directive from the test case definition file (act 206). For example, test driver 106 can access test directive 103 from test case definition 101. Method 200 includes an act of identifying that the second test directive is directed to an API included in a second different test library, APIs included in the second different test library configured to test the functionality of the second component (act 207). For example, test driver 106 can identify that test directive 103 is directed to API 185 in test library 145. Test driver 106 can used library ID 125 to identify test library 145 and API ID 126 to identify API 185.

Method 200 includes an act of dynamically invoking the second API with parameters included in the second test directive to test the functionality of the second component (act 208). For example, test driver 106 can issue invocation 103A to cause API 185 to be dynamically invoked with parameters 127 to test the functionality of component 155.

Invocation of API 185 can cause test data 172 to be sent to component 155. Component 155 can respond with results 162 indicating the component 155's response to test data 172. Test data 172 can include a call to a portion of the functionality of component 155 to simulate a condition component 155 can encounter during normal operation (e.g., an interaction with a series of other components in distributed system 108). Results 162 can indicate how component 155 responded to the simulated condition. For example, results 162 can indicate if component 155 responded as intended, if there was a performance deviation, if an error occurred, etc. Test library can appropriately format test data 162 into test data 162A and send test data 162A to test driver 106.

Method 200 includes an act of receiving results of the second API testing the first component (act 209). For example, test driver 106 can receive results 162A from test library 145. Test driver 106 can log results 162A and/or provide results 162A as input for a subsequent test.

Test driver 106 may continue to identify test directives in test case definition 101 until all test directives are processed. For example, test driver 106 can identify test directive 104. Test driver 106 can identify that test directive 104 is directed to API 183 in test library 143. Test driver 106 can used library ID 133 to identify test library 145 and API ID 134 to identify API 183. Test driver 106 can issue invocation 104A to cause API 183 to be dynamically invoked with parameters 135 to test the functionality of component 153.

Invocation of API 183 can cause test data 173 to be sent to component 153. Component 153 can respond with results 163 indicating the component 153's response to test data 173. Test data 173 can include a call to a portion of the functionality of component 153 to simulate a condition component 153 can encounter during normal operation (e.g., an interaction with a series of other components in distributed system 108). Results 163 can indicate how component 153 responded to the simulated condition. For example, results 163 can indicate if component 153 responded as intended, if there was a performance deviation, if an error occurred, etc. Test library can appropriately format test data 163 into test data 163A and send test data 163A to test driver 106.

Test driver 106 can log results 163A and/or provide results 163A as input for a subsequent test. Test driver 106 can also store results 163A in a table, such as, for example, a hash table, such that other test directives can access results 163A and use results 163A as input for other tests.

It may also be that test case definition includes other test directives that call exposed APIs in the components of distributed system 108. For example, a test directive can indicate that an exposed API included in component 154 is to be called to test component 154. Similar, test directives can be included to call exposed APIs included in any of components 151, 152, 153, and 155.

As previously described, output from testing one component can be provided input for testing another component. The following XML instructions represent an example of test directives that pass output from one tested component as input to another tested component:

```
1.  <TestSet xmlns:xsi=“http://www.w3.org/2001/XMLSchema-instance”
xsi:noNamespaceSchemaLocation=“test.xsd”>
2.  <Test ID=“1”>
3.  <Execution>
4.  <Call API=“Publishing” Method=“SubmitToPubSuite”
    NumberOfCalls=“1”>
5.  <Params>
6.  <Param Name=“XmlFile” Value=“a1.xml” />
7.  <Param Name=“PublishingServer” Value=
        “PubServerUnderTest” />
8.  </Params>
9.  </Call>
10.  </Execution>
11.  <Execution>
12.  <Call API=“ClientAPI” Method=“IsUpdateInstallable”
      NumberOfCalls=“1”>
13.  <Params>
14.  <Param Name=“GUID”
          Value=“$HASHTABLE:Publishing.SubmitToPubSuite_1”
          HashtableKey=“GUID” />
15.  </Params>
16.  </Call>
17.  </Execution>
18. </Test>
19. </TestSet>
```

Line 4 identifies the method “SubmitToPubSuite” from within :the “Publishing” API as the method that is to be executed to test a publishing component. Line 4 also indicates that the method “SubmitToPubSuite” is to be called one time. Lines 6 and 7 indicate that the method “SubmitToPubSuite” is to be called with parameter “XmlFile” having a value of “al.xml” and with parameter “Publishing Server” having a value of “riccerchpubs”.

Line 12 identifies the method “IsUpdatelnstallable” from within the “ClientAPI” API as the method that is to be executed to test a client component. Line 12 also indicates that the method “IsUpdatelnstallable” is to be called one time. Line 14 indicates that the method “IsUpdatelnstallable” is to be called with parameter “GUID”. Line 14 further indicates that the value for parameter “GUID” is to be accessed from a hash table of stored values and is a value from the results of testing the “SubmitToPubSuite” method. The value is to be accessed from a location in the hash table identified by the value “GUID” (i.e., the hash table key). Accordingly, embodiments of the present invention facilitate passing an output parameter from one component (e.g., a publishing component) to another component (e.g., a client component).

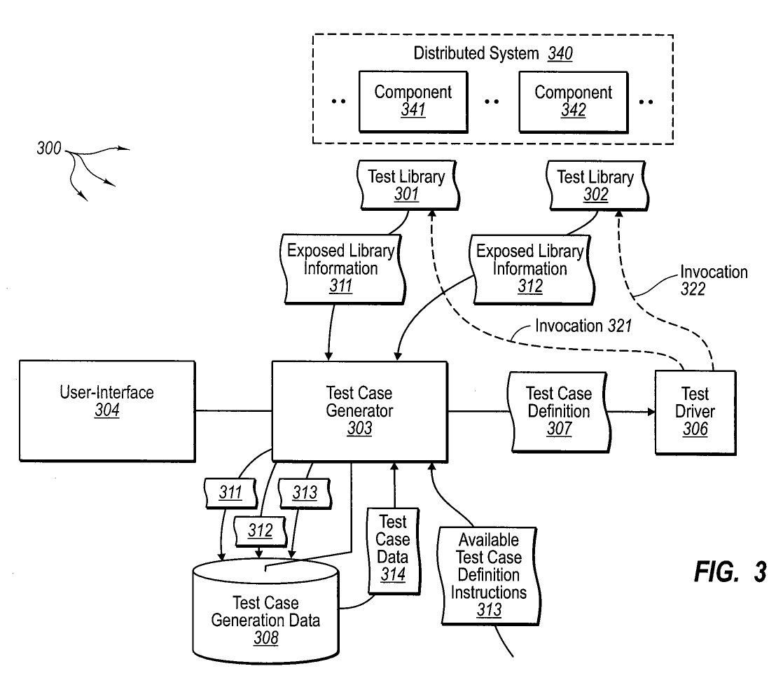

FIG. 3 illustrates an example computer architecture 300 that facilitates automated generation and execution of distributed component tests.

As depicted, computer architecture 300 includes user-interface 304, test case generator 303, test driver 306, and test case generation data 308. Generally, test case generator 303 can be configured to discover exposed library information, such as, for example, APIs and parameters, included in test libraries configured for testing distributed components. Test libraries 301 and 302 include APIs for testing components 341 and 342 of distributed system 340 respectively.

Thus, test case generator 303 can access libraries 301 and 302 and discover exposed library information 311 and exposed library information 312 from test libraries 301 and 302 respectively. Exposed library information 311 and 312 can include exposed APIs for testing components 341 and 34 respectively. Exposed library information 311 and 312 can also include corresponding parameter names and parameter formats for calling the identified APIs. Test case generator 303 can store exposed library information, including test information indication how exposed APIs are to be invoked, in test case generation data 308 to facilitate the automated generation of test case definitions.

Test case generator 303 can also discover test case definition instructions that can be used to automatically generate test case definitions. For example, test case generator 303 can discover available test case definition instructions 313. Available test case definition instructions 313 can include XML instructions and schemas for generating XML test case definitions. Test case generator 303 can store available test case definition instructions 313 to facilitate the automated generation of test case definitions.

Test case generator 303 can also be configured to generate a map of the components included in distributed system 304 and store the map in test case generation data 308.

User-interface 304 is configured to assist in creating and executing tests for testing components of distributed system 340. User-interface 304 can present one or more controls that can be manipulated to create test case definition 307. For example, user-interface can present a map of the components of distributed system 340. Each component of distributed system 340 can be represented by a corresponding map icon in the map.

For each component in the map, user-interface 304 can also present a list of APIs (e.g., in a drop down list) that are available for testing the component. To use an API to test a component, a user can select an API from the list. For example, a user can drag and drop an API onto a map icon for a component to indicate that the API is to be called to test the component.

In response, test case generator 303 can automatically utilize the stored information to create a test directive appropriately calling the API such that the user is relieved from having to know how to create the test directive. For example, test case generator 303 can access test case data 314 (or portion thereof) from test case generation data 308. Test case data 314 can include appropriate APIs and test case definition instructions (e.g., in XML).

Thus, a user can select various different APIs for various different distributed components through user-interface 304. As each API is selected, test case generator 303 can add the appropriate test directive to test case definition 307.

User-interface 304 can present the contents of a test case definition for further manipulation and/or customization by a user. For example, user-interface can include or call an editor that presents a test case definition in an editable text format. Through the editor, a user can change the test case definition, for example, adding further test directives, changing test directives, or deleting test directives. The editor can save any user changes

User-interface 304 can also include an execute control. When selected, the execute control causes test case generator 303 to send a test case definition to test driver 306. For example, in response to selection of an execute control, test case generator 303 can send test case definition 307 to test driver 306. Test driver 306 can execute test case definition 307 to test components of distributed system 340. For example, through invocations 321 and 322 test driver 306 can call APIs included in test library 301 and test library 302 respectively.

Thus, embodiments of the present invention facilitate invoking APIs inside a library with appropriate parameters to test a distributed component. Further, output parameters values from one API call and can be passed as input parameter values to a subsequent API call. Accordingly, end to end integration testing is possible for computing functionality that spans multiple components of a distributed system

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, a method for testing components of a distributed system, the method comprising:
an act of accessing a test case definition that defines test directives for testing a plurality of different components in the distributed system, including at least first and second interconnected components;
an act of accessing a first test directive from the test case definition file;
an act of identifying that the first test directive is directed to an API included in a first test library, APIs included in the first test library configured to test the functionality of the first component;
an act of dynamically invoking the first API with parameters included in the first test directive to test the functionality of the first component;
an act of receiving results of the first API testing the first component;
an act of accessing a second test directive from the test case definition file;
an act of identifying that the second test directive is directed to an API included in a second different test library, APIs included in the second different test library configured to test the functionality of the second component;
an act of dynamically invoking the second API with parameters included in the second test directive to test the functionality of the second component; and
an act of receiving results of the second API testing the first component.

2. The method as recited in claim 1, wherein the act of accessing a test case definition that defines test directives for testing a plurality of different components comprises an act of accessing a test case definition that defines test directives in a specified format, the specified format selected from among plain text, XML instructions, and an interpretable programming language.

3. The method as recited in claim 1, wherein the act of accessing a first test directive from the test case definition file comprises an act of accessing a test directive that identifies an API and includes parameters for calling the API.

4. The method as recited in claim 1, wherein the act of dynamically invoking the first API with parameters included in the first test directive includes an act of using reflection to access metadata indicating how the first API is to be invoked.

5. The method as recited in claim 1, wherein the act of dynamically invoking the first API with parameters included in the first test directive includes an act of invoking the first API with a parameter that was obtained from a hash table.

6. The method as recited in claim 1, wherein the act of dynamically invoking the first API to test the functionality of the first component comprises an act dynamically invoking the first API to test the functionality of a component selected from among an Internet Information Services component, a Web server component, a Database component, and an Operating System component.

7. The method as recited in claim 1, further comprising:
an act of storing results of the first API testing the first component.

8. The method as recited in claim 7, wherein the act of dynamically invoking the second API with parameters included in the second test directive comprises an act of invoking the second API with a parameter included in the stored results of testing the first component.

9. The method as recited claim 1, further comprising:
an act of invoking one or more other APIs to perform integrated end to end testing of the components of the distributed system, including testing at least the first and second components.

10. The method as recited in claim 1, further comprising:
an act of accessing the first test library prior to creation of the test case definition;
an act of discovering exposed APIs and corresponding parameters included in the first test library; and
an act of storing information for calling the exposed APIs with the corresponding parameters from a test case definition.

11. The method as recited in claim 9, further comprising:
an act of presenting a list of the APIs for testing the first component at at a user-interface;
an act of receiving a selection of the first API from among the list of APIs for testing the first component; and
an act of including a test directive to invoke the first API in the test case definition.

12. The method as recited in claim 1, further comprising:
an act of accessing available test case definition instructions prior to creation of the test case definition; and
an act of storing available test case definition instructions.

13. A computer program product for use at a computer system, the computer program product for implementing a method for testing components of a distributed system, the computer program product comprising one or more computer-readable storage media have stored thereon computer-executable instructions that, when executed at the computer system, cause the computer system to perform the following:
access a test case definition that defines test directives for testing a plurality of different components in the distributed system, including at least first and second interconnected components;
access a first test directive from the test case definition file;
identify that the first test directive is directed to an API included in a first test library, APIs included in the first test library configured to test the functionality of the first component;
dynamically invoke the first API with parameters included in the first test directive to test the functionality of the first component;
receive results of the first API testing the first component;
access a second test directive from the test case definition file;
identify that the second test directive is directed to an API included in a second different test library, APIs included in the second different test library configured to test the functionality of the second component;
dynamically invoke the second API with parameters included in the second test directive to test the functionality of the second component; and
receiving results of the second API testing the first component.

14. The computer program product as recited in claim 13, further comprising computer-executable instructions that, when executed at the computer system, cause the computer system to store results of the first API testing the first component.

15. The method as recited in claim 7, wherein computer-executable instructions that, when executed, cause the computer system to dynamically invoke the second API with parameters included in the second test directive to test the functionality of the second component comprise computer-executable instructions that, when executed, cause the computer system to invoke the second API with a parameter from the stored results of testing the first component.

16. At a computer system, a method for creating a test case definition for testing a distributed system, the method comprising:
an act of accessing one or more test libraries including exposed APIs for testing components of the distributed system;
an act of discovering the exposed APIs;
an act of storing information indicating how the exposed APIs are to be invoked;
an act of presenting a map of the distributed system along with a list of available APIs per distributed component at a user-interface;
an act of receiving a user selection indicating that a specified API is to be called to test a component of the distributed system; and
an act of automatically utilizing the stored information to create a test directive appropriately calling the API such that the user is relieved from having to know how to create the test directive.

17. The method as recited in claim 16, further comprising:
an act of accessing available test case definition instructions; and
an act of storing available test case definition instructions.

18. The method as recited in claim 17, wherein the act of accessing available test case definition instructions comprises an act of accessing XML instructions that can be processed by a test driver to invoke API calls for testing components of the distributed system.

19. The method as recited in claim 18, wherein the act of accessing XML instructions that can be processed by a test driver to invoke API calls for testing components of the distributed system comprises an act of accessing XML instructions that can invoke an API to test a component using input values that were output values of a prior API call.

20. The method as recited in claim 16, further comprising:
an act of a receiving a user-entered execute command; and
an act of sending the test directive to a test driver for execution in response to the receiving a user-entered execute command
